(19) United States
(12) Patent Application Publication
(10) Pub. No.: US 2010/0282716 A1
(43) Pub. Date: Nov. 11, 2010

(54) WELDING ASSEMBLY AND ASSOCIATED METHOD FOR WELDING, MECHANICALLY DEFORMING AND HEAT TREATING MATERIALS

(76) Inventor: Venkatasubramanian Ananthanarayanan, Beavercreek, OH (US)

Correspondence Address: Walters & Wasylyna, LLC, Post Office Box 751294, Dayton, OH, 45475, US

(21) Appl. No.: 12/437,188

(22) Filed: May 7, 2009

(51) Int. Cl. B23K 11/10; B23K 11/00

(52) U.S. Cl. 219/86.1; 219/117.1

(57) ABSTRACT

A welding assembly including a current generator, a first electrode electrically coupled to the current generator, the first electrode including a first engagement surface and defining a first recess in the first engagement surface, and a second electrode electrically coupled to the current generator, the second electrode including a second engagement surface and defining a second recess in the second engagement surface, wherein the first recess is aligned with the second recess.

### FIELD

The present patent application relates to welding assemblies and methods and, more particularly, to resistance welding assemblies having electrodes configured for welding, mechanically deforming and heat treating materials, such as titanium alloys.

### BACKGROUND

Titanium alloys find a wide variety of applications due to their favorable combination of mechanical properties, including strength-to-weight ratio and corrosion resistance, as well as good stiffness, toughness and light weight. The challenge with titanium alloys is to maintain these mechanical properties and corrosion resistance at weld joints and adjacent weld heat-affected-zones.

Titanium metal undergoes an allotropic phase transformation at about 885° C., changing from a hexagonal close-packed crystal structure (i.e., the alpha phase) at low temperatures to a body centered cubic crystal structure (i.e., the beta phase) at elevated temperatures. The transformation temperature, commonly referred to as the beta transus temperature, is strongly influenced by the content of interstitial elements such as oxygen, nitrogen and carbon (i.e., alpha stabilizers), hydrogen (a beta stabilizer) or other alloying elements that may be alpha or beta stabilizers.

Furthermore, iron content above 0.05 percent in unalloyed titanium products tends to cause a preferential corrosive attack of weld metal in nitric acid solutions. The corrosion is believed to be due to the acicular nature of any retained beta phase that is stabilized by iron. Consequently, iron content in the parent material and the weld filler metal is carefully controlled and kept below 0.05 percent, thereby limiting the use of higher strength products that tend to have higher iron contents. Similar issues are encountered in near-alpha titanium alloys as well.

Alpha-beta alloys, such as Ti-6Al-4V, are among the most commonly used titanium alloys. After solidification from the welding process and at elevated temperatures, the microstructure of these alloys consists almost completely of beta phase. As the material cools to room temperature, the beta phase undergoes martensitic transformation to the alpha prime or alpha-double-prime phase, depending on the composition. These martensitic phases tend to possess good tensile strength, but do not have as much ductility as the parent materials welded. Therefore, such materials typically require cold-working and heat treatment to improve the mechanical properties.

The weld sites and corresponding heat-affected zones of metastable-beta titanium alloys present microstructures that are similar to those found in alpha-beta alloys (i.e., they typically have high strength and relatively low ductility). Therefore, cold-working and heat treatment is generally also required to improve the mechanical properties of metastable-beta titanium alloys.

Those skilled in the art will appreciate that the cold-working and heat treatment processes are time consuming and tend to substantially increase the cost of welded titanium alloys when good mechanical properties are required. Also, the heat treatment processes, when carried out on the whole welded structure, may distort the structure out of shape. Heat treatment of large welded structures is often impractical. Consequently, local heat-treatment in and around only the areas affected by weld heat would be more practical and economical.

Accordingly, those skilled in the art continue to seek new welding techniques, including welding techniques that do not degrade the mechanical properties of the workpiece at and around the weld joint.

### SUMMARY

In one aspect, the disclosed welding assembly may include a current generator, a first electrode electrically coupled to the current generator, the first electrode including a first engagement surface and defining a first recess in the first engagement surface, and a second electrode electrically coupled to the current generator, the second electrode including a second engagement surface and defining a second recess in the second engagement surface, wherein the first recess is aligned with the second recess.

In another aspect, the disclosed method for welding and heat treating a workpiece may include the steps of positioning the workpiece between first and second welding electrodes, passing a first electric current through the workpiece to form a weld joint, passing a second electric current to thermo-mechanically deform the weld joint, and passing a third electric current through the workpiece to heat-treat the thermo-mechanically deformed weld joint.

In another aspect, the disclosed method for welding and heat treating a workpiece may include the steps of positioning the workpiece between first and second welding electrodes, the first electrode includes a first engagement surface and a first recess defined in the first engagement surface, the second electrode includes a second engagement surface and a second recess defined in the second engagement surface, passing a first electric current through the workpiece to form a weld joint, the weld joint including at least two protrusions extending from the workpiece, the protrusions corresponding to the first and second recesses, mechanically deforming the protrusions of the weld joint, and passing a second electric current through the workpiece to heat-treat the mechanically deformed weld joint.

In yet another aspect, the disclosed method for welding and heat treating a workpiece may be performed with a welding assembly that includes a first welding electrode, a second welding electrode and a current generator, wherein the first electrode includes a first engagement surface and a first recess defined in the first engagement surface, and the second electrode includes a second engagement surface and a second recess defined in the second engagement surface. The method may include the steps of (1) positioning the workpiece between the first and second welding electrodes, (2) passing a first electric current through the workpiece to form a weld joint, the weld joint being shaped, at least partially, by the first and second recesses, wherein the weld joint has a cross-sectional thickness, the cross-sectional thickness of the weld joint being greater than the combined cross-sectional thickness of the base members of the workpiece, (3) mechanically deforming the weld joint, and (4) passing a second electric current through the workpiece to heat-treat the mechanically deformed weld joint.

Other aspects of the disclosed welding assembly and associated method for welding, mechanically deforming and heat treating materials will become apparent from the following description, the accompanying drawings and the appended claims.

### BRIEF DESCRIPTION OF THE DRAWINGS

FIG. 1 is a schematic illustration of one aspect of the disclosed welding assembly, wherein the welding assembly includes first and second welding electrodes, which are shown in cross-section;

FIG. 2 is a cross-sectional view of alternative first and second welding electrodes useful in the welding assembly of FIG. 1;

FIG. 3 is a cross-sectional view of a welded workpiece formed using the first and second welding electrodes shown in FIG. 1;

FIG. 4 is a cross-sectional view of a welded workpiece formed using the alternative first and second welding electrodes shown in FIG. 2;

FIG. 5A is a cross-sectional view of a workpiece positioned between the first and second electrodes of the welding assembly of FIG. 1;

FIG. 5B is a cross-sectional view of the workpiece and first and second electrodes of FIG. 5A after a welding operation;

FIGS. 6A, 6B and 6C are cross-sectional views of various alternative workpieces positioned between the first and second welding electrodes of the welding assembly of FIG. 1;

FIG. 7 is a cross-sectional view of first and second heat treating electrodes in accordance with an aspect of the present disclosure, wherein the first and second heat treating electrodes of FIG. 7 may be substituted for the first and second welding electrodes of FIG. 1;

FIG. 8 is a cross-sectional view of a welded workpiece positioned between the first and second heat treating electrodes of FIG. 7.

FIG. 9 is a cross-sectional view of a welded workpiece positioned between alternative first and second heat treating electrodes; and

FIG. 10 is a flow chart illustrating one aspect of the disclosed method for welding, mechanically deforming and heat treating materials.

### DETAILED DESCRIPTION

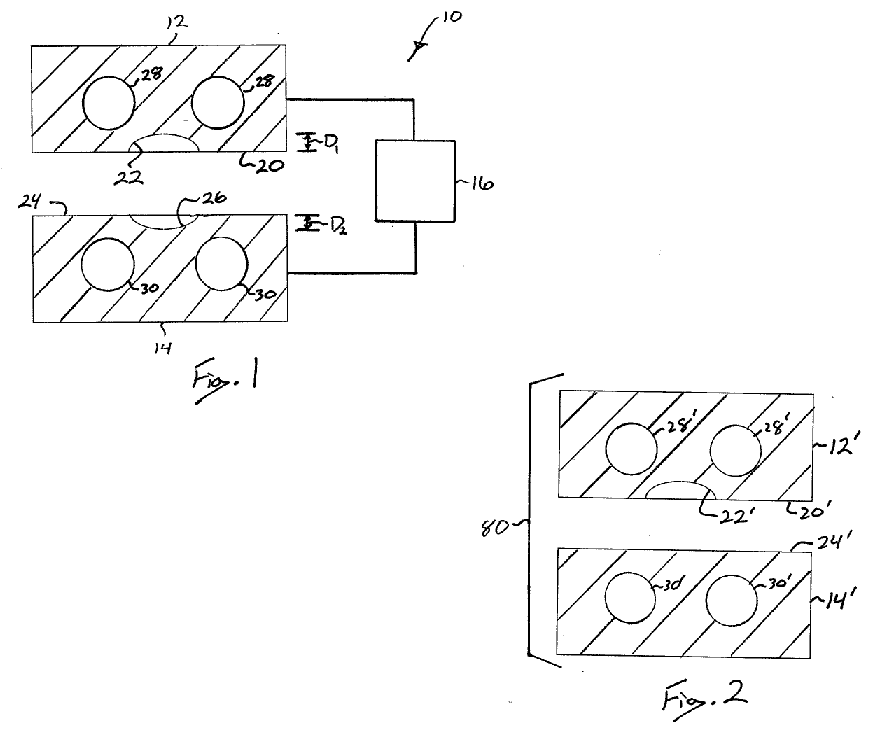

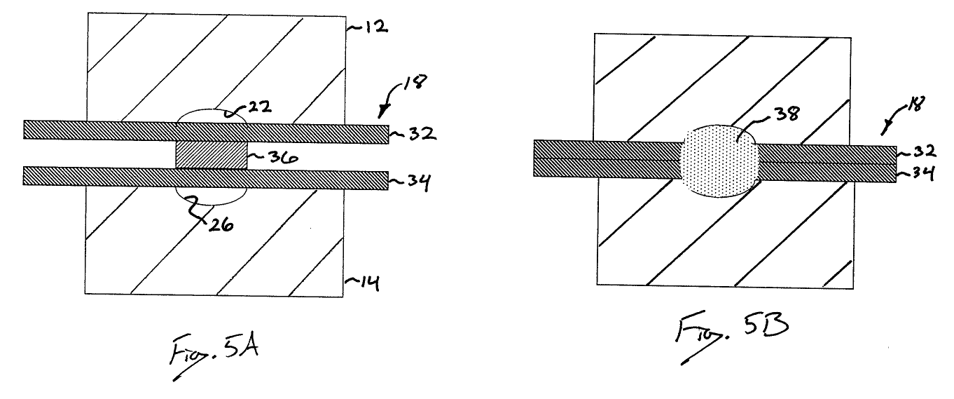

As shown in FIG. 1, one aspect of the disclosed welding assembly, generally designated 10, may include a first electrode 12, a second electrode 14 and a current generator 16. The first and second electrodes 12, 14 may be mounted on a support structure (not shown), such as a pair of moveable arms or one stationary arm and one moveable arm, capable of approximating the first and second electrodes 12, 14 to clamp a workpiece 18 therebetween and apply a mechanical force to the clamped workpiece 18, as shown in FIG. 5A.

The current generator 16 may be any source of electrical energy capable of supplying an electric current to the first and second electrodes 12, 14 to achieve resistive heating in the workpiece 18. In one aspect, the current generator 16 may include appropriate circuitry for supplying electric current to the first and second electrodes 12, 14, as well as controlling the magnitude and timing of the electric current being supplied to the first and second electrodes 12, 14. For example, the current generator 16 may be a direct current system, an alternating current system or a stored energy current system. At this point, those skilled in the art will appreciate that the current generator 16 may be a commercially available resistance welding machine or a component taken from a commercially available resistance welding machine.

The first and second electrodes 12, 14 may be formed from an electrically conductive material. Furthermore, the first and second electrodes 12, 14 may be formed from a material having a thermal conductivity (either relative high thermal conductivity or relatively low thermal conductivity) selected based upon the method step (discussed below) being performed by the first and second electrodes 12, 14. For example, the first and second electrodes 12, 14 may be formed from copper or copper alloys (e.g., Resistance Welder Manufacturers Association (“RWMA”) copper alloys Classes 1-5 and 20) when relatively high thermal conductivity is desired (e.g., when performing the step shown in block 54 of FIG. 10). Alternatively, the first and second electrodes 12, 14 may be formed from refractory materials, tungsten/copper alloys or molybdenum (RWMA Classes 10-14) when relatively low thermal conductivity is desired (e.g., when performing the steps shown in blocks 56 and 58 of FIG. 10).

The first and second electrodes 12, 14 may include fluid channels 28, 30 defined therein or connected thereto. A cooling fluid, such as water or ethylene glycol, may flow through the fluid channels 28, 30 to remove heat from the first and second electrodes 12, 14, as well as from the workpiece 18 (FIG. 5A) supported by the first and second electrodes 12, 14.

The first electrode 12 may be electrically coupled to the current generator 16 and may include a first engagement surface 20 and a recess 22 formed in the first engagement surface 20. The recess 22 may extend a distance D₁ into the first electrode 12 from the engagement surface 20 to provide the recess 22 with a desired first volume.

The second electrode 14 may be electrically coupled to the current generator 16 and may include a second engagement surface 24 and a recess 26 formed in the second engagement surface 24. The recess 26 may extend a distance D₂ into the second electrode 14 from the engagement surface 24 to provide the recess 26 with a desired second volume. The volume of the second recess 26 may be substantially the same as the volume of the first recess 22. However, those skilled in the art will appreciate that the volumes of the first and second recesses 22, 26 may be different without departing from the scope of the present disclosure.

One aspect of the disclosed method for welding, mechanically deforming and heat treating materials is shown in FIG. 10 and generally designated 50. The method 50 may be performed using the disclosed welding assembly 10. However, those skilled in the art will appreciate that other welding assemblies may be used to perform the method 50 without departing from the scope of the present disclosure.

At block 52, the method 50 may begin with the step of positioning a workpiece 18 between the first and second electrodes 12, 14 of the welding assembly 10, as shown in FIG. 5A. The first and second electrodes 12, 14 may apply a clamping force to the workpiece 18 to clamp the workpiece 18 therebetween.

Referring to FIG. 5A, the workpiece 18 may include one or more base members 32, 34 intended to be joined by welding. While two base members 32, 34 are shown in FIG. 5A, those skilled in the art will appreciate that additional base members may be included in the workpiece 18 without departing from the scope of the present disclosure.

The base members 32, 34 of the workpiece 18 may be formed from any material capable of being joined by resistive heating. In one aspect, the base members 32, 34 of the workpiece 18 may be formed from any metals or metal alloys capable of being joined by resistive heating. In one particular aspect, the base members 32, 34 of the workpiece 18 may be formed from titanium alloys, such as Ti-6Al-4V. However, those skilled in the art will appreciate that the disclosed method 50 may also be used to join materials that undergo similar phase transformations as titanium alloys, such as alloys of zirconium and hafnium, as well as duplex stainless steels.

Optionally, one or more of the base members 32, 34, as well as the auxiliary member 36 (discussed below) of the workpiece 18 may have surfaces that are have been plated or coated with an appropriate material to enhance welding and promote bonding.

Still referring to FIG. 5A, the workpiece 18 may additionally include one or more auxiliary member 36 to provide bulk to the weld joint 38 (FIG. 5B). The auxiliary member 36 may optionally be secured (e.g., tack welded) to one or more of the base members 32, 34 to ensure precise placement of the workpiece 18 in the welding assembly 10.

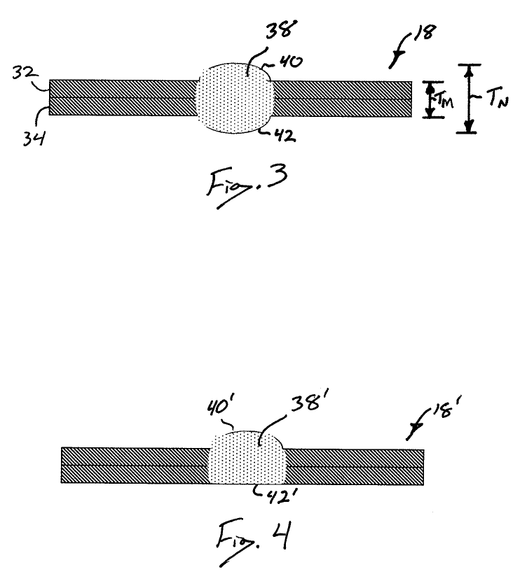

As shown in FIG. 5B, the auxiliary member 36 may have a size and thickness sufficient to form a weld joint 38 that has a cross-sectional thickness T_{N} (FIG. 3) that is greater than the cross-sectional thickness T_{M} (FIG. 3) of the welded members 32, 34. Those skilled in the art will appreciate that the size and thickness of the auxiliary member 36, as well as the volumes of the first and second recesses 22, 26, may be selected to achieve a desired thickness T_{N} of the weld joint 38 vis-à-vis the combined thickness T_{M} of the base members 32, 34.

The auxiliary member 36 may be formed from a material having the same or similar chemistry as the base members 32, 34, or from a material that is compatible with the material from which the base members 32, 34 are formed. For example, when the base members 32, 34 are formed from titanium alloys, the auxiliary member 36 may also be formed from a titanium alloy.

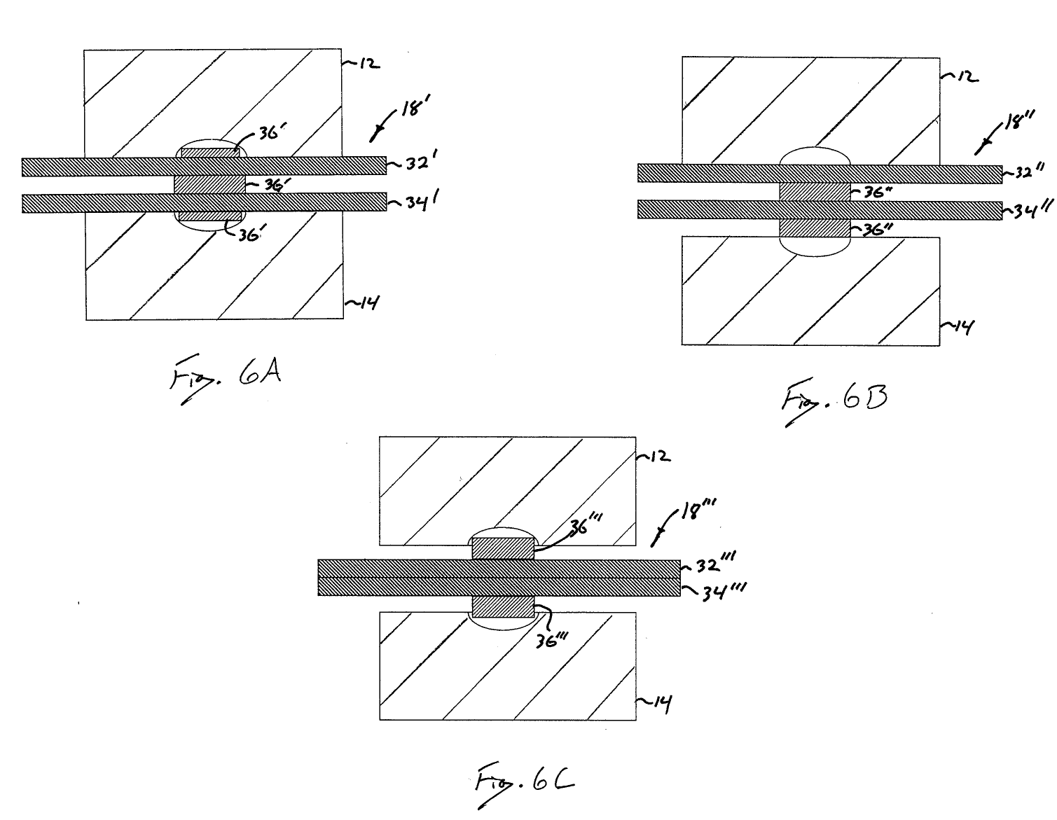

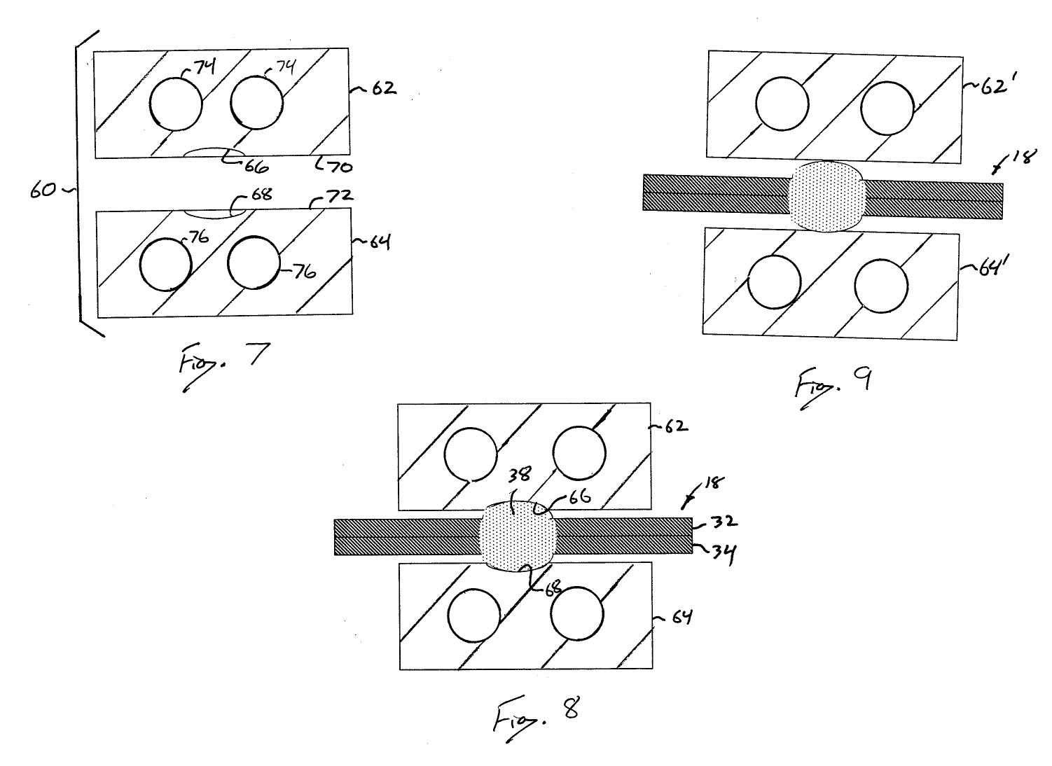

In FIG. 5A, a single auxiliary member 36 is shown positioned between the base members 32, 34. However, those skilled in the art will appreciate that various auxiliary members and configurations of auxiliary members vis-à-vis the base members may be used without departing from the scope of the present disclosure. Referring to FIG. 6A, in a first alternative aspect, auxiliary members 36′ may be positioned between the base members 32′, 34′, as well as external of the base members 32′, 34′. Referring to FIG. 6B, in a second alternative aspect, one auxiliary member 36″ may be positioned between the base members 32″, 34″ and one auxiliary member 36″ may be positioned external of base members 34′. Referring to FIG. 6C, in a third alternative aspect, a first auxiliary member 36′″ may be positioned external of base member 32′″ and a second auxiliary member 36′″ may be positioned external of base members 34′″, with no auxiliary members between the base members 32′″, 34′″.

Once the workpiece 18 has been positioned between the first and second electrodes 12, 14 of the welding assembly 10, as shown in FIG. 5A, welding may begin. At block 54 of FIG. 10, the current generator 16 (FIG. 1) may be actuated to pass a welding current through the workpiece 18 for a sufficient amount of time to raise the temperature of the workpiece 18 to a welding temperature, thereby forming the weld joint 38 in the workpiece 18, as shown in FIG. 5B. Those skilled in the art will appreciate that the welding time and temperature will depend on the material being welded, surface coatings, as well as whether a weld nugget or solid-state weld is desired for the weld joint 38. For example, when the workpiece 18 is formed from Ti-6Al-4V titanium alloy, the welding temperature may be at least half of the solidus temperature of the alloys welded in degrees Kelvin. If alloys with a range of solidus temperatures are welded, the welding temperature may be at least half of the lowest solidus temperature in degrees Kelvin.

At this point, those skilled in the art will appreciate that the weld joint 38 may have a size and shape dictated by the size and shape of the recesses 22, 26 in the first and second electrodes 12, 14, as well as the quantity of the auxiliary member 36 (FIG. 5A) used. Furthermore, as shown in FIG. 3 and discussed above, the weld joint 38 may have a cross-sectional thickness T_{N} that is greater than the combined cross-sectional thicknesses T_{M} of the welded members 32, 34, particularly the cross-sectional thickness of the adjacent heat-affected-zone, such that the weld joint 38 is a protruding weld joint, i.e., the weld joint 38 includes at least one protrusion (two protrusions 40, 42 are shown in FIG. 3) extending beyond the surface of the adjacent base members 32, 34.

The recesses 22, 26 in the first and second electrodes 12, 14 may be provided in various sizes, shapes and configurations to achieve a weld joint 38 having the desired shape and size. In one aspect, the recesses 22, 26 may be configured to form a spot weld. For example, the recesses 22, 26 may be generally paraboloidal or hemispherical recesses, thereby yielding a weld joint 38 at a single location (i.e., a spot weld) that has two generally convex (e.g., dome-shaped) protrusions 40, 42 (FIG. 3) extending from opposite sides of the base members 32, 34. However, those skilled in the art will appreciate that the protrusions 40, 42 of the weld joint 38 may be formed in various sizes and shapes (e.g., cylindrical or cubical). In another aspect, the recesses 22, 26 may be configured to form an elongated weld. For example, the recesses 22, 26 may be a elongated, trough-like recesses, thereby resulting in a generally elongated (e.g., linear) weld. In yet another aspect, the recesses 22, 26 may be configured to form a circumferential or partially circumferential weld. For example, the recesses 22, 26 may be circumferential, trough-like recess, thereby resulting in a generally circumferential weld joint 38 when the first electrode 12 is positioned exterior to a tube-like workpiece (not shown) and the second electrode 14 is positioned interior of the tube-like workpiece.

Referring again to FIG. 6, once the welding step (block 54) is complete, the method 50 may proceed to the next step (block 56).

Optionally, a cooling step may occur between blocks 54 and 56. In one aspect, the welded workpiece 18 (FIG. 5B) may be cooled by circulating cooling fluid through the fluid channels 28, 30 in the first and second electrodes 12, 14 while one or more of the first and second electrodes 12, 14 are engaged with the welded workpiece 18. In another aspect, the welded workpiece 18 may be air cooled by removing the welded workpiece from engagement with one or both of the first and second electrodes 12, 14. Additional cooling steps may be introduced between the various steps of the method 50 or combined with the various steps of the method 50 without departing from the scope of the present disclosure.

At block 56 (FIG. 10), the welded workpiece 18 (FIG. 3) may be mechanically deformed. Without being limited to any particular theory, it is believed that, depending on the material, mechanically deforming a weld joint 38 may create nucleation sites for recrystallization upon heat-treatment (block 58).

In one aspect, the weld joint 38 may be mechanically deformed using a cold process. One exemplary cold process for mechanically deforming the weld joint 38 includes passing the workpiece 18 between rollers (not shown), wherein the rollers a spaced to deform the weld joint 38 as the workpiece passes therethrough. A second exemplary cold process for mechanically deforming the weld joint 38 includes tamping the weld joint 38, which may be performed by hand or using a tamping machine. While these processes are described as being “cold processes,” those skilled in the art will appreciate that these cold processes may be performed with heat or when the workpiece is hot or warm.

In another aspect, the weld joint 38 may be mechanically deformed using the disclosed welding assembly 10 (i.e., a hot or warm deforming process). Referring to FIG. 7, an alternative pair 60 of deforming/heat-treating electrodes 62, 64 may be similar to the first and second electrodes 12, 14 described above. Specifically, the electrodes 62, 64 may include recesses 66, 68 formed in engagement surfaces 70, 72 thereof. Furthermore, the electrodes 62, 64 may be provide with optional flow channels 74, 76 for receiving a cooling fluid flow. However, the recesses 66, 68 of the deforming/heat-treating electrodes 62, 64 may define volumes that are smaller than the volumes defined by electrodes 12, 14. Indeed, in one alternative aspect, shown in FIG. 9, the deforming/heat-treating electrodes 62′, 64′ may include no recesses whatsoever.

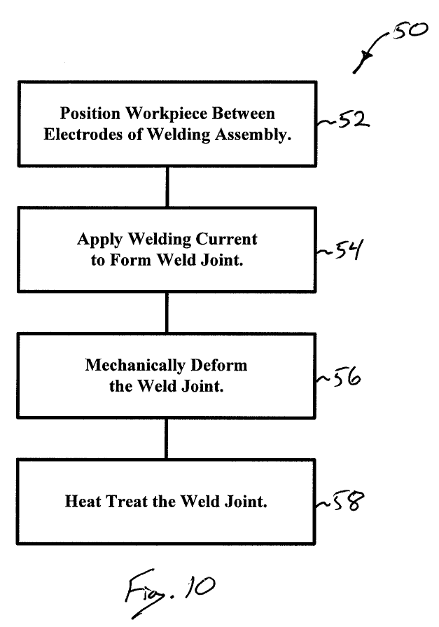

Thus, as shown in FIG. 8, the welded workpiece 18 may be positioned between the deforming/heat-treating electrodes 62, 64 such that the weld joint 38 is engaged by the recesses 66, 68 in the deforming/heat-treating electrodes 62, 64. The clamping force applied by the deforming/heat-treating electrodes 62, 64 may deform the weld joint 38. In one aspect, electric current may be passes through the weld joint 38 by way of the electrodes 62, 64, thereby heating the weld joint 38 and adjacent area to the desired working temperature to provide a warm or hot working deformation. The magnitude of the heating current and the duration of the heating current may be carefully controlled to generate a desired hot/warm working temperature for the material being processed. The clamping force applied by the electrodes 62, 64 may be adjusted to provide sufficient deformation of the weld joint 38, as well as the adjacent heat-affected zone, to facilitate the formation of nucleation sites.

Finally, at block 58 (FIG. 10), the weld joint 38 of the welded workpiece 18 may be heat treated. While the heat treatment will depend on the type of material being welded, exemplary heat treatment processes for titanium alloys include (1) anneal plus age, (2) recrystallization anneal and (3) mill anneal.

At this point, those skilled in the art will appreciate that the heat treatment step may be performed using the disclosed welding assembly 10 by passing an appropriate current through the weld joint 38 to achieve and maintain the desired temperature in the weld joint 38. In one particular aspect, the mechanically deforming (block 56) and heat treating (block 58) steps may be performed at the same time. Specifically, referring to FIG. 8, while the electrodes 62, 64 are applying a clamping force to deform the weld joint 38, the electrodes 62, 64 may simultaneously pass a current through the weld joint 38 to heat the weld joint 38 to the required heat treatment temperature (or temperatures).

Those skilled in the art will appreciate that the engagement surfaces 70, 72 of the electrodes 62, 64 may contact the base members 32, 34 of the welded workpiece 18 (i.e., the portion of the welded workpiece 18 adjacent to the weld joint 38) at the end of the combined mechanically deforming (block 56) and heat treating (block 58) steps. The size of the electrodes 62, 64, the timing of their contact with the welded workpiece 18, and the heat profiles in the weld joint 38 and adjacent portions of the base members 32, 34 may be controlled to generate the desired microstructures in the weld joint 38. For example, care may be taken to keep the temperature in the weld joint 38 below the beta-transus temperature of the workpiece 18 or the temperature above which a phase is stabilized that undergoes a martensitic transformation upon cooling.

For a titanium alloy, the temperature of the hot/warm working operation may be chosen as desired from room temperature up to any temperature below the beta-transus, and heat treatment may occur at one or several temperatures in this temperature range. In one aspect, blocks 56 and 58 may be combined into a single step, such as a hot/warm working plus a duplex anneal. In other words, the weld joint 38 may be subjected to a clamping force while simultaneously undergoing solution anneal at a temperature of about 50-75° C. below the beta transus temperature, followed by air cool (e.g., by releasing the electrodes 62, 64 while cooling), followed by aging at a temperature in the range of about 500-800° C. In another aspect, blocks 56 and 58 may be combined into a single step, such as a hot/warm working plus a solution treat and age operation. In other words, the weld joint 38 may be subjected to a clamping force while simultaneously undergoing solution anneal at a temperature of about 50-75° C. below the beta transus temperature, followed by rapid cooling (e.g., contact with water cooled electrodes), followed by aging at temperatures ranging from about 500-800° C. In yet another aspect, the weld joint 38 may be subjected to a clamping force while simultaneously undergoing recrystallization anneal. In yet another aspect, the weld joint 38 may be subjected to a clamping force while being heated to the alpha plus beta region (e.g., a temperature of about 700° C.), followed by mill anneal.

In one alternative aspect, the first and second electrodes 12, 14 of the welding assembly 10 may be replaced with the electrode pair 80 shown in FIG. 2. The electrode pair 80 may be configured to produce the welded workpiece 18′ shown in FIG. 4, wherein the weld joint 38′ includes one protruding side 40′ and one flat side 42′. Of course, those skilled in the art will appreciate that the weld joint 38′ may be formed in various shapes and sizes without departing from the scope of the present disclosure.

The electrode pair 80 may include a first electrode 12′ and a second electrode 14′. The first and second electrodes 12′, 14′ may be formed from the same or similar materials from which the first and second electrodes 12, 14 (FIG. 1) are formed. Furthermore, the first and second electrodes 12′. 14′ may include cooling channels 28′, 30′.

The first electrode 12′ may be electrically coupled to the current generator 16 (FIG. 1) and may include a first engagement surface 20′ and a recess 22′ formed in the first engagement surface 20′. The second electrode 14′ may be electrically coupled to the current generator 16 (FIG. 1) and may include a second engagement surface 24′ that does not include a recess.

Thus, the resulting weld joint 38′ may be shaped as shown in FIG. 4, with one protruding side 40′ and one flat side 42′. As such, the resulting weld joint 38′ may still have a thickness that is greater than the combined thickness of the adjacent base members 32, 34 (i.e., the adjacent heat-affected-zone) and, therefore, the weld joint 38′ can be mechanically deformed and heat-treated as described herein.

At this point, those skilled in the art will appreciate that the disclosed welding assembly 10 and method 50 provide a means for improving the microstructures of welded materials, such as titanium alloys. In particular, the present disclosure provides methods for welding, hot/warm working and further heat treatment that potentially use the same set of tooling. The disclosed methods may be used to develop primary alpha plus finely distributed alpha-prime and beta phases or alpha plus finely distributed metastable beta phases with improved ductility and corrosion resistance. The disclosed methods may also permit the use of iron contents higher than 0.05 percent in unalloyed titanium alloys and weld metal without the risk of preferential corrosion along acicular retained beta or alpha prime phases, by generating more favorable microstructures with finely distributed phases with good corrosion resistance similar to that of the base metal welded.

Although various aspects of the disclosed welding assembly and associated method for welding, mechanically deforming and heat treating materials have been shown and described, modifications may occur to those skilled in the art upon reading the specification. The present application includes such modifications and is limited only by the scope of the claims.

What is claimed is:

1. A welding assembly comprising:
a current generator;
a first electrode electrically coupled to said current generator, said first electrode including a first engagement surface and defining a first recess in said first engagement surface; and
a second electrode electrically coupled to said current generator, said second electrode including a second engagement surface and defining a second recess in said second engagement surface.

2. The welding assembly of claim 1 wherein said first recess is aligned with said second recess.

3. The welding assembly of claim 1 wherein said first and second recesses each have a paraboloidal shape.

4. The welding assembly of claim 1 wherein said first and second recesses are configured to form a spot weld joint.

5. The welding assembly of claim 1 wherein said first and second recesses are elongated recesses.

6. The welding assembly of claim 1 wherein said first and second recesses are circumferential recesses.

7. The welding assembly of claim 1 wherein at least one of said first and second electrodes includes a fluid channel thermally coupled therewith.

8. A method for welding and heat treating a workpiece using a welding assembly, said welding assembly including a first welding electrode, a second welding electrode and a current generator, said method comprising the steps of:
positioning said workpiece between said first and second welding electrodes;
passing a first electric current through said workpiece to form a weld joint and an adjacent heat-affected-zone;
mechanically deforming said weld joint; and
passing a second electric current through said workpiece to heat-treat said weld joint.

9. The method of claim 8 wherein said mechanically deforming and said passing said second electric current steps are performed simultaneously.

10. The method of claim 8 wherein said weld joint has a first cross-sectional thickness and said heat-affected-zone has a second cross-sectional thickness, said first cross-sectional thickness being greater than said second cross-sectional thickness.

11. The method of claim 8 wherein at least one of said first and second welding electrodes includes an engagement surface and a recess defined in said engagement surface, said recess defining a first volume, and wherein said weld joint is at least partially shaped by said recess.

12. The method of claim 11 further comprising the step of, prior to said mechanically deforming step, replacing said first and second welding electrodes with first and second heat-treating electrodes, said first and second heat-treating electrodes defining at least one recess therein, said recess of said first and second heat-treating electrodes defining a second volume, wherein said second volume is less than said first volume.

13. The method of claim 12 wherein said mechanically deforming step includes engaging said weld joint with said first and second heat-treating electrodes.

14. The method of claim 8 wherein said mechanically deforming step includes rolling or tamping said weld joint.

15. The method of claim 8 wherein said workpiece is formed from a titanium alloy.

16. The method of claim 8 wherein said passing said first electric current, said mechanically deforming and said passing said second electric current steps are performed without removing said workpiece from said welding assembly.

17. The method of claim 8 wherein said workpiece includes at least two base members and at least one auxiliary member.

18. A method for welding and heat treating a workpiece using a welding assembly, said workpiece including base members having a combined first cross-sectional thickness, said welding assembly including a first welding electrode, a second welding electrode and a current generator, said first electrode includes a first engagement and said second electrode includes a second engagement surface, wherein at least one of said first and second engagement surfaces includes a recess defined therein, said method comprising the steps of:
positioning said workpiece between said first and second welding electrodes;
passing a first electric current through said workpiece to form a weld joint, said weld joint being shaped, at least partially, by said recess, wherein said weld joint has a second cross-sectional thickness, said second cross-sectional thickness being greater than said combined first cross-sectional thickness;
mechanically deforming said weld joint; and
passing a second electric current through said workpiece to heat-treat said mechanically deformed weld joint.

19. The method of claim 18 wherein said passing said first electric current, said mechanically deforming and said passing said second electric current steps are performed in said welding assembly.

20. The method of claim 18 wherein said mechanically deforming and said passing said second electric current steps are performed simultaneously.
